(19) United States
(12) Patent Application Publication
(10) Pub. No.: US 2007/0122699 A1
(43) Pub. Date: May 31, 2007

(54) Electrochemical cells having improved gelling agents

(75) Inventor: Paul Pratt, Lone Rock, WI (US)

Correspondence Address: SENNIGER POWERS (RAYO), ONE METROPOLITAN SQUARE, 16TH FLOOR, ST. LOUIS, MO, 63102, US

(73) Assignee: Rovcal, Inc., Madison, WI (US)

(21) Appl. No.: 11/290,732

(22) Filed: Nov. 30, 2005

(51) Int. Cl. H01M 4/62; H01M 4/42

(52) U.S. Cl. 429/217; 429/229; 429/230; 429/232

(57) ABSTRACT

The present disclosure relates to alkaline electrochemical cells, such as metal-air cells, which comprise a gelled anode including an improved gelling agent. The gelling agent is a self-wetting, easy to disperse gelling agent that allows for even wet-up of the gelling agent during water intake. The even wet up allows the gelling agent to reach its full matrix potential and anode active material coating ability with provides for better diffusion characteristics. Additionally, the gelling agent has a high electrolyte tolerance and can withstand the solution pressure commonly associated with high pH systems.

### FIELD OF THE DISCLOSURE

The present disclosure generally relates to alkaline electrochemical cells. More specifically, the present disclosure relates to alkaline electrochemical cells, such as metal-air cells, which comprise a gelled anode, which may or may not include mercury, comprising an improved, modified gelling agent. The gelling agent has been modified to increase its hydrophobicity and thereby increase its self-wetting and dispersability properties in the presence of an electrolyte.

### BACKGROUND OF THE DISCLOSURE

Electrochemical cells, commonly known as “batteries,” are used to power a wide variety of devices used in everyday life. For example, devices such as radios, toys, cameras, flashlights, and hearing aids all ordinarily rely on one or more electrochemical cells to operate.

Electrochemical cells, such as metal-air electrochemical cells commonly utilized in hearing aids, produce electricity by electrochemically coupling in a cell a reactive gelled metallic anode, such as a zinc-containing gelled anode, to an air cathode through a suitable electrolyte, such as potassium hydroxide. As is known in the art, an air cathode is generally a sheet-like member having opposite surfaces that are exposed to the atmosphere and to an aqueous electrolyte of the cell, respectively. During operation of the cell, oxygen from the air dissociates at the cathode while metal (generally zinc) of the anode oxidizes, thereby providing a usable electric current flow through the external circuit between the anode and the cathode.

The gelling agent is present in the metallic anode to provide for mechanical structure and to coat the metallic particles to improve ionic conductivity within the anode during discharge. During the fabrication of the electrochemical cell, the gelling agent intakes water and swells within the anode to provide a structural matrix that ultimately suspends the metallic particles in the anode. One problem frequently encountered with conventional gelling agents is that they tend to take in water, or wet, very quickly when contacted with the electrolyte such that the interior mass of the gelling agent may not be completely swollen as a skin may tend to form on the exterior of the gelling agent and block additional water intake into the interior portion of the matrix. This phenomena can result in a substantially dry interior that leads to clumps of dry gelling agent being present in the anode. These clumps are not desirable as they can negatively affect cell performance due to a reduction in anode active material coating ability, and a reduction in mechanical support of the electrolyte.

Additionally, some conventional gelling agents for gelled anodes may not provide the desired level of electrolyte tolerance within the anode upon fabrication; that is, some conventional gelling agents may not provide sufficient stability and functionality in higher pH systems common to anode chemistries. If the gel matrix structure formed during wetting is not sufficient to withstand the solution pressure from high electrolyte concentrations, the gel structure can partially or fully collapse resulting in the inability of the gelled matrix to hold electrolyte and coat the metallic particles.

As such, it would be desirable to provide an electrochemical cell comprising a gelled anode comprising an improved gelling agent having improved self-wetting properties to allow that gelling agent to fully wet and swell the interior of the gelling agent. Additionally, it would be beneficial to provide a gelling agent capable of withstanding the solution pressure commonly associated with high pH electrolyte systems to allow for the formation of a strong, stabile gel matrix.

### SUMMARY OF THE DISCLOSURE

The present disclosure provides an electrochemical cell having improved service life and extended shelf life. The cell includes a gelled anode comprising a gelling agent and an anode active material. The anode active material typically comprises zinc. The gelling agent is a self-wetting, easy to disperse gelling agent that allows for even wet-up of the gelling agent during water intake. The even wet up allows the gelling agent to reach its full matrix potential and anode active material coating ability and provides for better diffusion characteristics. Additionally, the gelling agent has a high electrolyte tolerance and can withstand the solution pressure commonly associated with high pH electrolyte systems. The gelling agents as described in this disclosure are generally hydrophobically modified gelling agents and have a dispersion time as defined herein of less than about 3 minutes and a low to medium hydrophilic/lipophilic balance.

As such, the present disclosure is directed to an electrochemical cell comprising a gelled anode comprising a gelling agent and an anode active material comprising zinc. The gelling agent has a dispersion time as defined herein of less than about 3 minutes.

### BRIEF DESCRIPTION OF THE DRAWINGS

FIG. 1 is a schematic sectional side elevational view of a conventional metal-air button cell constructed in accordance with one embodiment of the present disclosure.

### DETAILED DESCRIPTION OF THE DISCLOSURE

The present disclosure is generally directed to electrochemical cells having a gelled anode including an anode active material comprising zinc and a gelling agent. The gelling agents are self-wetting, easy to disperse gelling agents such that they allow for even wet up of the gelling agent during water intake so that the gelling agents form a strong gel matrix capable of thoroughly coating the anode active material and reducing the amount of unwetted, unused gelling agent. Because the anode active material is more evenly and thoroughly coated in the anode, the performance of the electrochemical cell is improved.

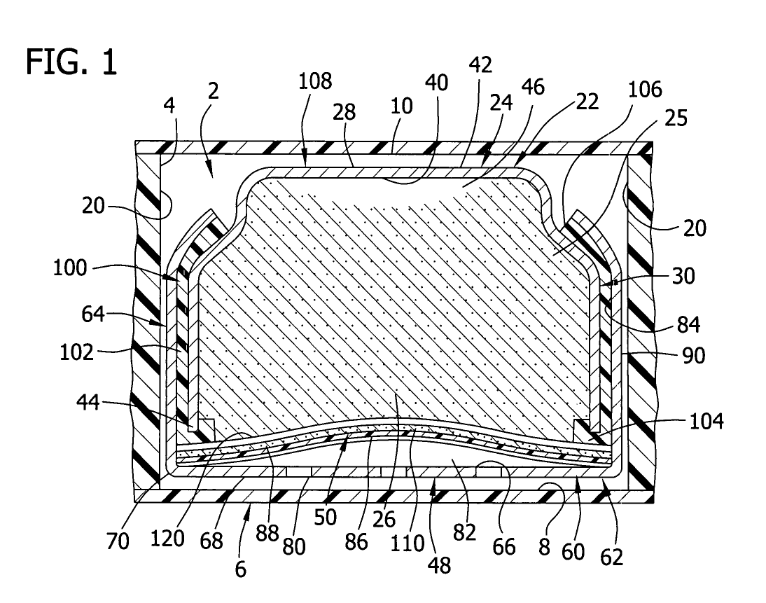

Referring now to FIG. 1, a conventional metal-air cell, and in particular a conventional button cell 2, is deposited in a battery cavity 4 of an appliance 6. The cavity 4 is generally bounded by a bottom wall 8, a top wall 10, and side walls 20.

The negative electrode of the cell 2, commonly known as the anode 22, includes an anode can 24 defining an anode/electrolyte chamber 25, which contains a gelled anode 26 comprising a gelling agent, an anode active material and other additives, and an alkaline electrolyte comprising an alkaline electrolyte solution and other additives, each of which is discussed in further detail below. Conventional anodes typically consist of a zinc paste anode active material, and may be positioned in the manner described in, for example, U.S. patent application Ser. No. 10/944,036, which is hereby incorporated by reference as if set forth in its entirety herein.

The anode can 24 has a top wall 28 and an annular downwardly-depending side wall 30. Top wall 28 and side wall 30 have, in combination, an inner surface 40 and an outer surface 42. Side wall 30 terminates in an annular can foot 44, and defines a cavity 46 within the anode can 24, which contains the gelled anode 26.

The positive electrode of the cell 2, commonly known as the cathode 48, includes a cathode assembly 50 contained within a cathode can 60. Cathode can 60 has a bottom 62 and an annular upstanding side wall 64. Bottom 62 has a generally flat inner surface 66, a generally flat outer surface 68, and an outer perimeter 70 defined on the flat outer surface 68. Side wall 64 of the cathode can has an inner surface 84 and an outer surface 90. Suitable air cathodes for use in the present disclosure are described in U.S. Pat. Nos. 5,378,562, 5,308,711, and 6,780,347, each of which is hereby incorporated by reference as if set forth in its entirety, and mixtures of any of the foregoing. One or more air ports 80 extend through the bottom 62 of the cathode can 60 to provide avenues for air to flow into the cathode 48. An air reservoir 82 spaces the cathode assembly 50 from the bottom 62 and the corresponding air ports 80. A porous air diffusion layer 86 occupies the air reservoir 82, and presents an outer reaction surface 88 for the oxygen. It should be appreciated by those of skill in the art that an air mover, not shown, could additionally be installed to assist in air circulation.

The cathode assembly 50 includes an active layer 110 that is interposed between a separator 120 and the air diffusion layer 86. Active layer 110 reduces the oxygen from the air, consuming the electrons produced by the reaction at the anode 22. Separator 120 has the primary function of preventing anodic zinc particles from coming into physical contact with the elements of the cathode assembly 50. Separator 120, however, does permit passage of hydroxyl ions and water therethrough between the anode 22 and the cathode assembly 50. The separator 120 is preferably a microporous membrane, typically wettable polypropylene. Other suitable separator materials are described in U.S. patent application Ser. No. 10/914,934, the contents of which is hereby incorporated by reference as if set forth in its entirety.

The anode 22 is electrically insulated from the cathode 48, via the seal 100, that includes an annular side wall 102 disposed between the upstanding side wall 64 of the cathode can 60 and the downwardly-depending side wall 30 of the anode can 24. A seal foot 104 is disposed generally between the can foot 44 of the anode can 24 and the cathode assembly 50. A seal top 106 is positioned at the locus where the side wall 102 of the seal 100 extends from between the side walls 30 and 64 adjacent to the top of the cell 2.

Generally, the seal 100 is of single-piece construction. For example, the seal 100 may be molded of nylon 6,6 which has been found to be inert to the alkaline electrolyte contained in the gelled anode 26, and yet also sufficiently deformable upon compression to function as a seal against the inside wall 84 of the cathode can 60. It is contemplated that the seal 100 may alternatively be formed of other suitable materials, including without limitation polyolefin, polysulfone, polypropylene, filled polypropylene (e.g., talc-filled polypropylene), sulfonated polyethylene, polystyrene, impact-modified polystyrene, glass filled nylon, ethylene-tetrafluoroethylene copolymer, high density polypropylene and other insulating materials. One particular example of a suitable glass filled nylon material for use in forming the sealing assembly is disclosed in co-assigned U.S. Patent Publication No. 2004/0145344, the disclosure of which is incorporated herein by reference to the extent that it is consistent.

The outer surface 108 of the cell 2 is thus defined by portions of the outer surface 42 of the top of the anode can 24, outer surface 90 of the side wall 64 of the cathode can 60, outer surface 68 of the bottom 62 of the cathode can 60, and the top 106 of seal 100.

As noted above, the present disclosure is directed to an electrochemical cell having, for example, the above-described configuration. More specifically, the present disclosure is directed to an electrochemical cell comprising a gelled anode comprising a self-wetting gelling agent and an anode active material, typically comprising zinc. Additional components such as an ionically conductive clay additive, mercury or other corrosion inhibitors, an electronic conducting polymer, and an electrolyte, which includes an alkaline electrolyte solution, a suspending agent, and a surfactant, may also be included in the anode as described herein. Generally speaking, the gelled anode of the present disclosure may be fabricated by first preparing an electrolyte, then preparing the coated metal anode, and finally combining the electrolyte and the coated metal anode.

The Electrolyte Fabrication Process

The electrolyte fabrication process typically involves forming the electrolyte solution comprising water, an alkaline solution, a suspending agent, a surfactant, and zinc oxide. Suitable alkaline solutions include aqueous solutions of potassium hydroxide, sodium hydroxide, lithium hydroxide, and combinations thereof. Generally, the electrolyte solution comprises from about 20% (by weight) to about 50% (by weight), and desirably from about 25% (by weight) to about 40% (by weight) alkaline solution.

The electrolyte fabrication process also includes introducing a suspending agent into the electrolyte solution. The suspending agent is present in the electrolyte solution to suspend the surfactant present therein. The suspending agent can be any suspending agent that is known to be used in electrochemical cells. Suitable suspending agents include, for example, carboxymethylcellulose (CMC), polyacrylic acid, and sodium polyacrylate (e.g., some of those under the Carbopol® trademark, which are commercially available from Noveon, Inc., Cleveland, Ohio). The suspending agent is typically present in the electrolyte solution at a concentration of from about 0.05% (by weight) to about 1% (by weight), desirably about 0.1% (by weight) electrolyte solution. In a particularly preferred embodiment, the suspending agent is a non-crosslinked polymeric material, or a low-crosslinked polymeric material, such that in use, it is substantially non-rigid and has long-flow properties.

The electrolyte fabrication process also includes adding a surfactant to the electrolyte solution. Preferably, the surfactant is an oxazoline surfactant. Suitable oxazoline surfactants can be dispersed in an anode-compatible electrolyte during the electrolyte fabrication process, or can be suspended under the anode fabrication process. U.S. Pat. No. 3,389,145, incorporated by reference herein as if set forth in its entirety, discloses structures of one suitable set of oxazolines and processes for making the same. Also suitable for use in the gelled anode of the present disclosure are substituted oxazoline surfactants having the structures shown in U.S. Pat. No. 3,336,145, in U.S. Pat. No. 4,536,300, in U.S. Pat No. 5,758,374 and in U.S. Pat. No. 5,407,500, each of which is hereby incorporated by reference as if set forth in its entirety, and mixtures of any of the foregoing. A most preferred oxazoline surfactant, ethanol, 2,2′-[(2-heptadecyl-4(5H)-oxazolylidine)bis(methyleneoxy-2,1-ethanediyloxy)]bis, has a structure shown as Formula (I-2) in incorporated U.S. Pat. No. 5,407,500. This is a compound commercially available from Angus Chemical (Northbrook, Ill.) and sold under the trademark Alkaterge™ T-IV. Preferably, the surfactant is present at a concentration of from about 0.1% (by weight) to about 1% (by weight), and desirably about 0.2% (by weight) electrolyte solution.

The electrolyte fabrication process additionally includes adding zinc oxide to the electrolyte solution. Specifically, the zinc oxide is present in the electrolyte solution to reduce dendrite growth, which reduces the potential for internal short circuits by reducing the potential for separator puncturing. Although preferred, in any of the embodiments described herein, the zinc oxide need not be provided in the electrolyte solution, as an equilibrium quantity of zinc oxide is ultimately self-generated in situ over time by the exposure of zinc to the alkaline environment and the operating conditions inside the cell, with or without the addition of zinc oxide per se. The zinc used in forming the zinc oxide is drawn from the zinc already in the cell, and the hydroxide is drawn from the hydroxyl ions already in the cell. Where zinc oxide is added to the electrolyte solution, the zinc oxide is preferably present in an amount of from about 0.5% (by weight) to about 4% (by weight), desirably about 2% (by weight) electrolyte solution.

In an exemplary embodiment, the electrolyte solution comprises an alkaline solution comprising potassium hydroxide in water, zinc oxide, a suspending agent, and a surfactant. In a particularly preferred embodiment, the electrolyte solution comprises potassium hydroxide in water (30-50% by weight), zinc oxide, a polyacrylic acid suspending agent, and an oxazoline surfactant.

The Coated metal Anode Fabrication Process

The coated metal anode fabrication process typically involves mixing an anode active material, which typically comprises zinc, a gelling agent, and optionally, an ionically conductive clay additive. Additionally, other optional components such as a wetting agent, an electronic conducting polymer, or a corrosion inhibitor may optionally be added to produce the coated metal anode.

In general, the anode active material, which is typically in particulate metal alloy form as a powder, can be any suitable anode active material that is known to be used in electrochemical cells having an aqueous alkaline environment. Preferably, the metal alloy powder is a zinc-containing powder. In one specific embodiment, the surface of the zinc powder is amalgamated with mercury to produce a zinc-mercury alloy according to the process described in U.S. Pat. No. 4,460,543 to Glaeser, the contents of which is hereby incorporated by reference as if set forth in its entirety. According to this process, zinc powder is mixed with metallic mercury in the presence of an amalgamation aid in a closed system at a partial pressure of oxygen below 100 mbar. The amalgamation aid is typically a substance that is suitable for dissolving the oxide layer of the zinc powder and preventing the formation of an oxide layer on the mercury. During the amalgamation process, the excess amalgamation aid, water vapor, and other volatile products are preferably continuously removed from the closed system. To complete the process, the partial pressure of oxygen is raised to atmospheric pressure. The mercury present in the amalgamation acts to passivate the zinc particles which generally results in reduced anode gassing and improved efficiency.

During the amalgamation process, the mercury penetrates through the surface of the zinc powder and into the zinc powder particles and is distributed therein through diffusion. Smaller zinc powder particles have a correspondingly larger surface area per unit volume, and due to their increased contribution to gassing, have more mercury available for the passivation of impurities on the surface than do larger particles. As a result of the absorption of mercury by the surface of the zinc powder, there is initially a stronger coating of mercury on the surface of the zinc, i.e., where the mercury is specifically needed. This effect is increased through the use of certain amalgamation aids, such as soda lye, potash lye, hydrochloric acid, acetic acid, formic acid, carbonic acid, and ammonia. According to the amalgamation process, the zinc powder is preferably mixed with an alloying element that has been predissolved in metallic mercury to further reduce gas development and improve corrosion resistance. These alloying elements include gold, silver, tin, lead, cadmium, indium, thallium, and gallium. As such, the mercury-amalgamated zinc alloy may additionally contain one or more of these alloying elements. A preferred element is lead.

Typically, the zinc powder used in the anode fabrication process is zinc powder that has been amalgamated with greater than about 0.5 parts mercury per 100 parts zinc. Desirably, the zinc powder has been amalgamated with less than about 6.0 parts mercury per 100 parts zinc. More preferably, the zinc powder has been amalgamated with from about 1 part mercury per 100 parts zinc to about 5 parts mercury per 100 parts zinc, and desirably from about 2 parts mercury per 100 parts zinc to about 4 parts mercury per 100 parts zinc. In a particularly preferred embodiment, the zinc powder has been amalgamated with about 2.4 parts mercury per 100 parts zinc.

In another embodiment, the zinc alloy comprises zinc, mercury, and lead. Desirably, mercury is present in an amount of from about 1 part mercury per 100 parts zinc to about 5 parts mercury per 100 parts zinc, and lead is present in an amount of from about 100 ppm to about 1000 ppm, desirably about 500 ppm.

The zinc powder utilized typically has a mean particle size of from about 200 to about 400 micrometers. Generally, the median particle size of the zinc powder is about 200 to about 300 micrometers. The zinc powder typically has an apparent density in the range of about 2 to about 4 gram/cm³ and a flow rate of less than about 70 seconds and desirably less than about 50 seconds. One method for the measurement of the apparent density of the zinc powder is ASTM B 212-99 “Standard Test Method for Apparent Density of Free-Flowing Metal Powders Using the Hall Flowmeter Funnel,” ASTM International. One method for the measurement of the flow rate of the zinc powder is ASTM B 213-03 “Standard Test Method for Flow Rate of Metal Powders,” ASTM International.

During fabrication of the anode, a gelling agent is added, typically in dry powder form, and mixed with the zinc alloy, or other anode active material. The gelling agent, once swollen, acts to support the electrolyte and coat the anode active material (typically zinc-containing) in the gelled anode. The gelling agent also increases the distribution of the electrolyte throughout the anode, and reduces zinc self-plating, which can result in undesirable hardening of the anode. The gelling agent is generally a chemical compound that has negatively charged acid groups.

The gelling agent described in this disclosure present in the anode is a self-wetting gelling agent that allows for even wet-up during water intake; that is, the gelling agent intakes water present in the electrolyte solution at a slower pace than conventional gelling agents such that both the exterior and the interior regions of the gelling agent take up water and swell. Because the gelling agents are self-wetting, they resist forming an initial “skin” on the outer surface of the powder particles that would reduce the interior intake of water and reduce or delay the swelling of the gelling agent. Slower water intake allows the gel structure formed to reach a more full matrix potential, which results in better diffusion characteristics and improved anode active material coating. In one embodiment, the gelling agents are conventional gelling agents such as carboxymethylcellulose (CMC), polyacrylic acid, or sodium polyacrylate (e.g., those under the Carbopol® trademark, which are commercially available from Noveon, Inc., Cleveland, Ohio) that have been hydrophobicly modified to improve their overall gelling properties. The hydrophobic modification of the gelling allows the gelling agent to have improved hydrophobic properties and slow down the rate of water intake during the wetting process. The gelling agents may be modified, for example, during synthesis with hydrophobic surfactants and/or through the addition of hydrophobic co-monomers.

The gelling agents as described in this disclosure additionally have high electrolyte tolerance; that is, the gelling agents have high stability and functionality in high pH systems, such as those encountered with an alkaline electrolyte. The gelling agents as described herein form a highly stable, strong gel matrix that is capable of withstanding the solution pressure associated with high electrolyte concentrations. This high solution pressure can cause gel structures to collapse in some systems, and collapsed systems do not hold electrolyte or coat anode active materials very well.

Preferred gelling agents of the present disclosure are self-wetting gelling agents that have a dispersion time, as defined herein, of less than about 3 minutes, suitably less than about 1 minute, more suitably less than about 30 seconds, and even more suitably less than about 20 seconds. The dispersion time of a specific gelling agent can be determined for purposes of this disclosure by conducting the following analysis: (1) 39 grams of room temperature deionized water are introduced into a 100 milliliter beaker and a 4 centimeter plastic blade (such as that on a LabMaster Rotary Mixer) is introduced into the deionized water and energized to stir at about 600 rpm; and (2) 1 gram of gelling agent is introduced into the room temperature deionized water being stirred and the mixture visually monitored until the gelling agent is dispersed, at which time the amount of time that has passed since the introduction of the gelling agent into the room temperature deionized water and the dispersion is recorded as the dispersion time. The gelling agent is deemed “dispersed” when it is substantially homogeneous such that no un-hydrated dry gel nor globules are visibly present in the dispersion.

The gelling agents as described in this disclosure may additionally be characterized in terms of their hydrophilic/lipophilic balance (HLB). Gelling agents can be characterized in terms of HLB as low, medium, or high HLB gelling agents. Conventional gelling agents are typically high HLB gelling agents; that is, they are typically water loving gelling agents such that they will rapidly absorb water from an electrolyte upon wetting. As noted herein, this rapid intake can lead to the formation of a skin on the outer layers of the gelling agent and reduce interior water intake and swelling. The gelling agents of the present disclosure, however, can be characterized as medium to low HLB gelling agents; that is, they are more oil loving as compared to conventional gelling agents. This characteristic of the gelling agents as described herein makes water absorption from the electrolyte comparatively slower, and provides for improved overall wetting and matrix-forming as described herein.

Preferred commercially available gelling agents for use in the present disclosure include, for example, Carbopol® Ultrez 10, Carbopol® Ultrez 21, Carbopol® ETD 2020, ETD polymers (Noveon), hydrophobically modified polymers, and combinations thereof.

Typically, the gelling agent is present in the coated metallic anode at a concentration of less than about 5.0% (by weight anode blend). Preferably, the gelling agent is present in the coated metallic anode at a concentration of greater than about 0.5% (by weight anode blend). More preferably, gelling agent is present in the coated metallic anode at a concentration of from about 0.1% (by weight anode blend) to about 3% (by weight anode blend). Most preferably, the gelling agent is present in the coated metallic anode at a concentration of from about 0.2% (by weight anode blend) to about 2% (by weight anode blend).

Optionally added to the anode active material and gelling agent is an ionically conductive clay additive. Generally, this additive is in powder form. The ionically conductive clay additive is preferably an ionically conductive clay additive that advantageously exhibits high stability in concentrated alkaline electrolytes, and has substantially no effect on the gassing behavior of the zinc used as the anode active material in alkaline electrochemical cells. Additionally, because the ionically conductive clay is insoluble in an aqueous alkaline or neutral electrolyte solution, dispersed clay particles throughout the anode form an ionic network that enhance the transport of hydroxyl ions through the matrix formed by the gelling agent.

The ionically conductive clay additives suitable for use in the anode of the present disclosure are synthetically modified ionically conductive clay additives. Either natural or synthetic clays can be synthetically modified to produce ionically conductive clay additives suitable for use in the present disclosure. Generally, natural or synthetic clay materials suitable for synthetic modification typically have a hydroxide group, a particle charge, and at least one of aluminum, lithium, magnesium and silicon. Specifically, natural or synthetic clays such as, for example, kaolinite clays, montmorillonite clays, smectite clays, illiet clays, bentonite clays, hectorite clays, and combinations thereof may be suitable for synthetic modification and use in the anodes and electrochemical cells described herein.

The clay additives may be synthetically modified to increase their negative charge density on the surface. This increase in negative charge density allows for a significant increase in the interaction with the gelling agents described above, and allows a polymer matrix to build a solid structure that will provide additional support from within the gelling agent matrix after the acid groups are ionized. This results in an increase in the overall conductivity of the anode.

Ionically conductive clay additives suitable for use in the present disclosure may be chemically modified to introduce halogen atoms into the chemical structure of the additive. These halogen atoms typically replace the hydroxide ions present in the ionically conductive clay additive to increase the negative charge density of the modified ionically conductive clay additive. Generally, the higher the modification (i.e., the more halogen atoms introduced into the structure to replace hydroxide ions), the greater the increase in charge density. Although any halogen atom (i.e., fluorine, chlorine, bromine, iodine or astatine) can be introduced alone or in combination to increase the charge density of the modified ionically conductive clay additive, fluorine is generally preferred.

Modified ionically conductive clay additives suitable for use in the anodes and electrochemical cells of the present disclosure may include an increased amount of halogen atoms as compared to conventional ionically conductive clay additives. Generally, to be suitable for use in the anodes and electrochemical cells of the present disclosure, the modified ionically conductive clay additive will have a concentration of halogen atoms of at least about 25,000 ppm, more desirably at least about 50,000 ppm, still more desirably at least about 80,000 ppm and most desirably at least about 100,000 ppm or more. In one particularly preferred embodiment, the modified ionically conductive clay additive comprises at least about 50,000 ppm fluorine, desirably at least about 80,000 ppm fluorine, still more desirably at least about 100,000 ppm fluorine, and most desirably at least about 120,000 ppm fluorine.

Modified ionically conductive clay additives including substituted halogen atoms suitable for use in the anodes and electrochemical cells of the present disclosure may also be characterized in terms of their cationic exchange capacity. The cationic exchange capacity of the ionically conductive clay additive is the quantity of positively charged ions (i.e., cations) that the clay additive can accommodate on its negatively charged surface, expressed as milliequivalents per 100 grams of clay material. As the cationic exchange capacity of the ionically conductive clay additive increases, so does its ability to enhance the ionic and electric conductivity within the electrochemical cell and improve the transport of alkaline electrolyte between the cathode and the anode.

Suitable modified ionically conductive clay additives have a cationic exchange capacity of at least about 70 milliequivalents/100 grams, desirably at least about 80 milliequivalents/100 grams, more desirably at least about 90 milliequivalents/100 grams, still more desirably at least about 100 milliequivalents/100 grams, still more desirably at least about 110 milliequivalents/100 grams, and still more desirably at least about 120 milliequivalents/100 grams of ionically conductive clay additive. The cationic exchange capacity of the modified ionically conductive clay additive can easily be determined by one skilled in the art using, for example, a titrimetric procedure using methylene blue as the indicating agent. The methylene blue is cationic and will exchange with the sodium at the surface of the crystal. The absorbed methylene blue results in the precipitation of the crystal/methylene blue complex. Once the solution demonstrates the first sign of color (free methylene blue), the end point is reached.

Specifically, suitable modified ionically conductive clay additives for use in the anodes and electrochemical cells as described herein include, for example, SR 2478 and SR 2477, both commercially available from Rockwood Specialties Inc., Princeton, N.J. SR 2478 is a fluorinated Laponite® clay additive that has a cationic exchange capacity of about 95-100 milliequivalents/100 grams. SR 2477 is also a fluorinated Laponite® clay additive that has a cationic exchange capacity of about 120-130 milliequivalents/100 grams. As compared to Laponite® RD (non-fluorinated Laponite® ionically conductive clay additive having the empirical formula (Na_{0.70}^{0.7+}[(Si₈Mg_{5.5}Li_{0.3})O₂₀(OH)₄]^{0.7-}) that has a cationic exchange capacity of about 55-60 milliequivalents/100 grams, the fluorinated ionically conductive clay additives have a much greater cationic exchange capacity; that is, the fluorinated ionically conductive clay additives have significantly increased negative surface charge density.

Typically, the modified ionically conductive clay additive is present in the coated metallic anode at a concentration of from about 0.1% (by weight anode blend) to about 3% (by weight anode blend). Desirably, the modified ionically conductive clay additive is present in the coated metallic anode at a concentration of from about 0.1% (by weight anode blend) to about 1% (by weight anode blend); more desirably from about 0.1% (by weight anode blend) to about 0.3% (by weight anode blend).

Along with the gelling agent, anode active material, and ionically conductive clay additive, magnesium oxide may optionally be added in dry powder form during the coated metal anode fabrication. Magnesium oxide may be introduced into the anode to improve the self-wetting properties of the anode upon combination with the electrolyte; that is, the magnesium oxide helps to soak electrolyte into the anode by wicking the electrolyte into the anode. This wicking action helps to evenly distribute the electrolyte through the anode. Typically, magnesium oxide (or other suitable wetting agents, when utilized) is present in the coated metallic anode at a concentration of from about 0.1% (by weight anode blend) to 4% (by weight anode blend). Desirably, magnesium oxide (or other suitable wetting agents, when utilized) is present in the coated metallic anode at a concentration of about 2% (by weight anode blend).

An electronic conducting polymer may also optionally be added to the coated metallic anode to improve its properties. The electronic conducting polymer generally promotes increased electronic conductivity between zinc particles, and provides increased ionic conductivity in the electrolyte. The electronic conducting polymer additionally decreases the voltage dip upon initial discharge, eliminates impedance during discharge, and produces higher overall operating voltage.

Preferably, the electronic conducting polymer is polyaniline. Other electronic conducting polymers such as polypyrrole, polyacetylene, and combinations thereof may also be used. Typically, the electronic conducting polymer is added to the zinc alloy at 2 parts for every 3 parts of the gelling agent.

Small amounts of one or more corrosion inhibitors may also optionally be added to the coated metallic anode. The corrosion inhibitor added to the anode can be any corrosion inhibitor that is known to be used in electrochemical cells. Typically, the corrosion inhibitor is a substance known to improve the corrosion behavior of anodic zinc. Suitable corrosion inhibitors include, for example, tannic acid, aluminum, indium, lead, bismuth, and combinations thereof.

It is contemplated that the above-described coated metallic anode components used in the anode fabrication process may be combined in any particular order. For example, the ionically conductive clay additive may be added to the zinc alloy prior to adding the gelling agent, and/or the magnesium oxide, and/or the electronic conducting polymer, if any. Alternatively, the ionically conductive clay additive can be added to the alkaline electrolyte at any point during the electrolyte fabrication process, described above.

In one specific embodiment, the combined dry mixture of the anode active material comprising zinc amalgamated with mercury, gelling agent, ionically conductive clay additive, and magnesium oxide, are dry blended by mixing them in an orbital mixer for about 5-10 minutes, depending on the batch size. After dry blending, the combined mixture is typically placed in a rotational tumbler, and water is sprayed on the tumbling dry mixture until a wet sand texture is achieved. The wet blended mixture is then spread out in a thin layer and allowed to dry, typically for about 24 hours. The dried material is then screened using screen sizes 18 and 30 or 18 and 40. Finally, the dried material (coated material) is blended with amalgamated zinc alloy powder in a ratio of, for example from about 1:1 to about 3:1, preferably about 2:1 (uncoated:coated).

As used herein, the term “anode blend” is meant to include all of the components that go into making the coated metal anode; that is, “anode blend” includes the anode active material, the gelling agent, the ionically conductive clay additive, if present, and any other optional components, such as a wetting agent, electronic conducting polymer, and/or a corrosion inhibitor.

The Gelled Anode Formation

Generally speaking, the gelled anode for use in the electrochemical cell of the present disclosure is formed by combining the coated metallic anode with the surfactant-based electrolyte solution. More specifically, the coated metallic anode is dry-dispensed into the cell and then the surfactant-based alkaline electrolyte solution is dispensed onto the coated metallic anode and absorbed. Once the surfactant-based alkaline electrolyte solution has been absorbed by the coated metallic anode, the cell may be mechanically closed.

Generally, the gelled anode comprises from about 70% (by weight) to about 90% (by weight) coated metallic anode, and from about 10% (by weight) to about 30% (by weight) surfactant-based alkaline electrolyte solution.

While the present disclosure has been described and illustrated in combination with an zinc-air button cell, the improved gelling agents of the present disclosure may be added to any metallic based anode in any type of electrochemical cell including, but not limited to, zinc-manganese dioxide cells, zinc-silver oxide cells, metal-air cells including zinc in the anode, nickel-zinc cells, rechargeable zinc/alkaline/manganese dioxide (RAM) cells, zinc-bromide cells, zinc-copper oxide cells, or any other cell having a zinc-based anode. It should also be appreciated that the present disclosure is applicable to any suitable cylindrical metal-air cell, such as those sized and shaped, for example, as AA, AAA, AAAA, C, and D cells.

Having described the disclosure in detail, it will be apparent that modifications and variations are possible without departing the scope of the disclosure defined in the appended claims. Furthermore, it should be appreciated that all examples in the present disclosure are provided as non-limiting examples.

### EXAMPLE 1

In this Example, the dispersion time of three commercially available gelling agents was determined. The three commercially available gelling agents, all of which are commercially available from Noveon, Inc. (Cleveland, Ohio), were Carbopol® 934 (Sample A), Carbopol® ETD 2020 (Sample B), and Carbopol® Ultrez 10 (Sample C).

39 grams of room temperature deionized water was introduced into a 100 milliliter beaker and a 4 centimeter plastic blade (LabMaster Rotary Mixer) was introduced into the deionized water and energized to stir at about 600 rpm. To the mixing deionized water was added 1 gram of the gelling agent to be tested and the mixture was visually monitored until the gelling agent was dispersed, at which time the amount of time that had passed since the introduction of the gelling agent into the room temperature deionized water and the formation of the dispersion was recorded as the dispersion time. Each gelling agent was tested three times and the dispersion times averaged. The results are shown in Table 1.

TABLE 1

| | Dispersion |
|---|---|
| Sample | Time |
| A | >6 minutes |
| B | 17 seconds |
| C | 28 seconds |

As the data in Table 1 indicate, the Carbopol® 934, which is a conventional, non-hydrophobically modified gelling agent, had not completely dispersed after six minutes. At six minutes, there were large unhydrated dry gel globules present in the beaker. This indicates that a skin formed on the some of the outer layers of the gelling agent thus blocking complete water uptake. Conversely, the Carbopol® ETD 2020 and the Carbopol® Ultrez 10, both of which are hydrophobically modified gelling agents, became dispersed in under 30 seconds indicating that there were substantially no unhydrated gel globules present. As such, when these modified gelling agents are used in the anodes of an electrochemical cell, they will provide an extended matrix capable of substantially coating the anode active material and increasing battery performance.

what is claimed is:

1. An electrochemical cell comprising a gelled anode comprising a gelling agent and an anode active material comprising zinc, the gelling agent having a dispersion time as defined herein of less than about 3 minutes.

2. The electrochemical cell as set forth in claim 1 wherein the gelling agent has a dispersion time as defined herein of less than about 1 minute.

3. The electrochemical cell as set forth in claim 1 wherein the gelling agent has a dispersion time as defined herein of less than about 30 seconds.

4. The electrochemical cell as set forth in claim 1 wherein the gelling agent has a dispersion time as defined herein of less than about 20 seconds.

5. The electrochemical cell as set forth in claim 1 wherein the anode active material comprising zinc is an amalgamated zinc composition comprising zinc and mercury.

6. The electrochemical cell as set forth in claim 1 wherein the anode active material comprising zinc is an amalgamated zinc composition comprising zinc, mercury, and lead.

7. The electrochemical cell as set forth in claim 6 wherein the amalgamated zinc composition comprises from about 0.5 parts mercury per 100 parts zinc to about 6.0 parts mercury per 100 parts zinc.

8. The electrochemical cell as set forth in claim 6 wherein the amalgamated zinc composition comprises about 2.4 parts mercury per 100 parts zinc.

9. The electrochemical cell as set forth in claim 6 wherein the mean particle size of the amalgamated zinc composition is from about 200 micrometers to about 320 micrometers.

10. The electrochemical cell as set forth in claim 6 wherein the median particle size of the amalgamated zinc composition is from about 240 micrometers to about 270 micrometers.

11. The electrochemical cell as set forth in claim 1 wherein the gelling agent is present in an amount of from about 0.1% (by weight anode blend) to about 3% (by weight anode blend).

12. The electrochemical cell as set forth in claim 1 wherein the gelling agent is selected from the group consisting of hydrophobically modified carboxymethylcellulose, hydrophobically modified polyacrylic acid, hydrophobically modified sodium polyacrylate, and combinations thereof.

13. The electrochemical cell as set forth in claim 1 further comprising from about 0.1% (by weight anode blend) to about 2% (by weight anode blend) magnesium oxide.

14. The electrochemical cell as set forth in claim 1 wherein the gelled anode further comprises an electrolyte solution.

15. The electrochemical cell as set forth in claim 14 wherein the electrolyte solution comprises water, an alkaline solution, a suspending agent, a surfactant, and zinc oxide.

16. The electrochemical cell as set forth in claim 15 wherein the surfactant is an oxazoline surfactant.

17. The electrochemical cell as set forth in claim 15 wherein the electrolyte solution comprises from about 20% (by weight) to about 50% (by weight) potassium hydroxide, about 2% (by weight) zinc oxide, about 0.1% (by weight) suspending agent, and about 0.2% (by weight) surfactant.

18. The electrochemical cell as set forth in claim 1 wherein the gelled anode additionally comprises an ionically conductive clay additive that is dispersed throughout the gelled anode, wherein the ionically conductive clay additive comprises at least about 25,000 ppm of a halogen.

19. The electrochemical cell as set forth in claim 18 wherein the ionically conductive clay additive comprises at least about 100,000 ppm of a halogen.

20. The electrochemical cell as set forth in claim 18 wherein the halogen is fluorine.

21. The electrochemical cell as set forth in claim 18 wherein the halogen is chlorine.

22. The electrochemical cell as set forth in claim 18 wherein the halogen is bromine.
